(19) United States
(12) Patent Application Publication
(10) Pub. No.: US 2025/0109642 A1
(43) Pub. Date: Apr. 3, 2025

(54) METHODS OF RADIATION ACTIVATED LOST CIRCULATION MATERIAL PREVENTION

(71) Applicant: SAUDI ARABIAN OIL COMPANY, Dhahran (SA)

(72) Inventors: Maxim Orlov, Moscow (RU); Timur Zharnikov, Moscow (RU); Abdullah S. Al-Yami, Dhahran (SA)

(73) Assignee: SAUDI ARABIAN OIL COMPANY, Dhahran (SA)

(21) Appl. No.: 18/729,185

(22) PCT Filed: Feb. 24, 2023
(86) PCT No.: PCT/US2023/013757

§ 371 Date: Jul. 16, 2024

(30) Foreign Application Priority Data
Feb. 24, 2022 (RU) 2022104774

(51) Int. Cl. E21B 21/00; E21B 47/117

(52) U.S. Cl. CPC E21B 21/003; E21B 47/117

(57) ABSTRACT

A system for treating a lost circulation zone within a wellbore that includes a treatment sub 300 is provided. The treatment sub 300 includes a communications device, an internal fluid conduit 1016 configured to convey a wellbore fluid through the treatment sub 100, and the interior 327 of the treatment sub 300 is between a sub exterior surface 328 and the internal fluid conduit 1016. The treatment sub 300 also includes a radiation source 352 configured to generate a form of radiation within a wellbore fluid. Further provided are methods of using the system to treat loss circulation zones.

### BACKGROUND

Various challenges are encountered during drilling and production operations of a hydrocarbon production well. For example, fluids used in drilling, completion, or servicing of a wellbore can be lost to a subterranean formation. In particular, the fluids may enter the subterranean formation via depleted zones, zones of relatively reduced pressure (as compared to the wellbore), “loss circulation zones” having naturally occurring fractures, weak zones having fracture gradients exceeded by the hydrostatic pressure of the drilling fluid, and so forth. The extent of fluid losses to the formation may range from minor losses (for example, less than 10 barrels/hour (bbl/hr)), also referred to as “seepage loss”, to severe losses (for example, greater than 100 bbl/hr), to even greater amounts, such as where fluid fails to return to the surface (“complete fluid loss”). As well, the type of degree fluid loss may differ depending on the type of fluid in the wellbore. The degree of loss for oil- and synthetic oil-based muds is considered more significant versus the same quantity for water-based muds due to the potential economic and environmental impacts.

Lost circulation can be encountered during any stage of operations. Lost circulation may occur when drilling fluid (or drilling mud) pumped into a well returns partially or does not return to the surface. While de minimis fluid loss is expected, excessive fluid loss is not desirable from a safety, an economical, or an environmental point of view. This is especially true when working with water-bearing formations, such as aquifers that have drinking quality fresh or mineral water, or such as brine- or formation water-bearing formations, which may contaminate hydrocarbon production, cause corrosion issues, and foul cement jobs. Lost circulation is associated with problems with well control, borehole instability, pipe sticking, unsuccessful production tests, poor hydrocarbon production after well completion, and formation damage due to plugging of pores and pore throats by mud particles. Lost circulation problems may also contribute to non-productive time (NPT) for a drilling operation. In extreme cases, lost circulation problems may force abandonment of a well.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a treatment sub useful for treating a lost circulation zone. The treatment sub comprises a communications device configured to receive an external communication and an internal fluid conduit configured to convey a wellbore fluid through the treatment sub. The treatment sub also comprises an interior defined between a sub exterior surface and the internal fluid conduit. The treatment sub may include a radiation source configured to generate at least one form of radiation in the wellbore fluid.

In another aspect, embodiments disclosed herein relate to a method of treating a lost circulation zone during a wellbore drilling program. The method comprises introducing into a wellbore a treatment sub, where the treatment sub is part of a bottom hole assembly of a drill string used in the wellbore drilling program. The method further comprises detecting lost circulation of a wellbore fluid from the wellbore, introducing a resin agent into the wellbore fluid, introducing a crosslinking agent into the wellbore fluid, operating the treatment sub such that at least one form of radiation is generated in the wellbore fluid, maintaining both the wellbore and the treatment sub for a treatment period, and determining that lost circulation of the wellbore fluid from the wellbore has been mitigated.

Other aspects and advantages of the claimed subject matter will be apparent from the following description and the appended claims.

### BRIEF DESCRIPTION OF DRAWINGS

This section describes specific embodiments in detail with reference to the accompanying figures. Where the figures include like elements between them, they may be denoted by like reference numerals. The use of letters with a number may indicate a like element, apparatus, or system; however, there is a material change between the like element, apparatus, or system. The use of the prime or “′” mark with a numeral may indicate a like element in a different state of operation or condition than previously referenced; however, other aspects remain the same.

FIG. 1 is a diagram that illustrates a well environment with a treatment system in accordance with one or more embodiments.

FIG. 2 shows a representation of the interaction between a resin agent and a crosslinking agent in accordance with one or more embodiments.

FIGS. 3A-C show an exterior front, a top, and a partial side internal view, respectively, of a treatment sub in accordance with one or more embodiments.

FIGS. 4A-C show several configurations of a treatment sub in accordance with one or more embodiments.

FIGS. 5A-E show several configurations of a treatment sub in accordance with one or more embodiments.

FIGS. 6A-D show in partial reveal several optional configurations of a treatment sub in accordance in one or more embodiments.

FIG. 7 is a flow chart depicting a method for treating a lost circulation zone in accordance with one or more embodiments.

Typically, down is toward or at the bottom and up is toward or at the top of the figure. “Up” and “down” are oriented relative to a local vertical direction. However, in the oil and gas industry, one or more activity takes place in deviated or horizontal wells. Therefore, one or more figure may represent an activity in deviated or horizontal wellbore configuration.

“Uphole” may refer to objects, units, or processes that are positioned closer to the surface entry in a wellbore. “Downhole” may refer to objects, units, or processes that are positioned farther from the surface entry in a wellbore. The terms “upstring” and “downstring” may relate in similar ways to a position along a string of tools or pipe, such as a drill string, while positioned in a wellbore. The terms “upflow” and “downflow” may relate in similar ways to a position relative to the general flow of a fluid, such as a wellbore or drilling fluid circulating in a wellbore. The terms are relativistic and may not be considered mutually exclusive. For example, a first unit may be described as “upstring” from a second unit but also be “downflow” from the same relative to the flow of a fluid in a wellbore annulus.

### DETAILED DESCRIPTION

Treating lost circulation during drilling is a common operation in formations that are fractured, highly permeable, porous, cavernous, or vugular. Epoxy-based systems are useful to solve the problem of the lost circulation. Such epoxy-based systems are typically hardened using curing or crosslinking agents. However, one of the known challenges with epoxy-based systems is initiating hardening or crosslinking in the section of the wellbore so that the system effectively blocks the leakage but not the wellbore. Furthermore, it is beneficial to treat the lost circulation during drilling operations such that progress in the drilling program is not seriously compromised.

The present disclosure relates to systems, apparatuses, and methods for treating loss circulation zones (LCZs) by forming lost circulation material (LCM) proximate to the LCZs. The chemical system product is used with a triggering apparatus—a treatment sub —to facilitate the interaction of the reactive components of the chemical system in situ to remedy LCZs of all sizes, configurations, and loss rates. The chemical system in combination with the triggering apparatus improves operational safety, uptime for drilling equipment and personnel, and prevents wellbore fluid losses, including potentially catastrophic losses that may endanger the environment or personnel.

### Treatment Systems

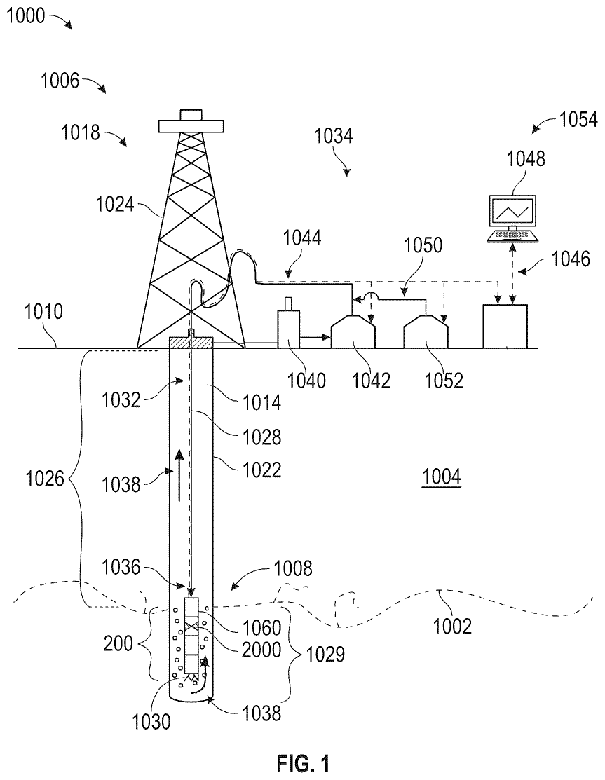

FIG. 1 is a diagram that illustrates a well environment with a treatment system in accordance with one or more embodiments. In FIG. 1, the well environment 1000 includes a lost circulation zone 1002 located among the subsurface formations 1004. Well system 1006 is shown traversing subsurface formation 1004 and is in fluid communication with lost circulation zone 1002 through lost circulation zone face 1008.

Subsurface formations 1004 may include one or more porous or fractured rock formation that resides beneath the surface 1010. The surface 1010 may be dry land or ocean bottom. Well system 1006 may be formed for the purposes of developing a hydrocarbon well, such as an oil well, a gas well, a gas condensate well, a mixture thereof, or another type of well, such as a fresh, brine, or mineral water well. The subsurface formations 1004 and the lost circulation zone 1002 may each have heterogeneity with varying characteristics, such as degree of density, permeability, porosity, pressure, temperature, and fluid saturations of the rock within each formation.

In the instance of the well system 1006 intending to be operated as a production well, the well system 1006 may facilitate the extraction of hydrocarbons (or “production”) from a reservoir or otherwise hydrocarbon-bearing formation. In the case of the well system 1006 being operated as an injection well, the well system 1006 may facilitate the injection of fluids into the subsurface formations 1004. In the case of the well system 1006 being operated as a monitoring well, the well system 1006 may facilitate the monitoring of various characteristics of the subsurface formations 1004, such as pressure or saturation of a particular formation.

The well system 1006 may include a wellbore 1014, a well control system (or “control system”) 1016, and a drilling system 1018. The control system 1054 may regulate various operations of the well system 1006, such as well drilling operations, well completion operations, well production operations, or well or formation monitoring operations.

The wellbore 1014 may include a bored hole that extends from the surface 1010 into the subsurface formations 1004 such that fluid communication is established with the lost circulation zone 1002. Wellbore 1014 is a void that is defined by wellbore wall 1022. Although shown as a vertical well, the configuration of the wellbore 1014 may also be deviated, approximately horizontal or horizontal, and combinations thereof, as a person of ordinary skill in the art well appreciates. The one or more embodiments are adaptable and applicable to all wellbore configurations.

The wellbore 1014 may be created, for example, by the drilling system 1018 boring through the subsurface formation 1004. In one or more embodiments, the drilling system 1018 includes a drilling rig 1024 supporting and manipulating a drill string 1026. The drill string 1026 may include drill pipe 1028 with a bottom hole assembly (BHA) 1029 coupled to the distal end of the drill pipe 1028. Drill pipe 1028 may also include drill collars. A drill bit 1030, which features members that can bore through the subsurface formations 1004 to form the wellbore 1014, is part of and attached to the distal end of the drill string 1026.

In one or more embodiments, the treatment system comprises a treatment sub as a component of a drill string. As shown in FIG. 1, treatment sub 2000 is shown as part of BHA 1029 upstring of drill bit 1030. As part of the BHA, the treatment sub may be positioned similarly as a logging while drilling (LWD) or measurement while drilling (MWD) tool would be positioned as a person of skill in the art would appreciate. The treatment sub may be positioned along the BHA proximate to the drill bit to provide for an expedient response to detection and treatment of a lost circulation zone. However, in doing so, one of skill may recognize that structures such as shock collar or other impact-deflecting or absorbing coupling between the treatment sub and the drill bit may be appropriate to protect the radiation generation sources that are part of the treatment sub, as will be described further.

Treatment sub 2000 in FIG. 1 is shown physically positioned proximate to and downhole of the lost circulation zone face 1008 such that a treatment may be applied. Such physical positioning versus the face of the LCZ may depend on a number of factors, such as, but not limited to, the physical configuration of the treatment sub and the BHA, the location of the face of the lost circulation zone, the radiation source configuration, that is, the direction in which the generated radiation forms, and how the LCM agent capsules are introduced into the wellbore fluid.

In one or more embodiments, the treatment sub is positioned upstream of the face of the lost circulation zone. “Upstream” in this sense is relative to the circulation pathway of wellbore fluid. Being positioned upstream based upon the flow of the wellbore fluid permits the treatment sub to initiate a treatment, such as generation of a form of radiation, such that the lost circulation material (LCM) forms before or within the face of the LCZ. If wellbore fluid is circulating downhole through the drill string 1026 and uphole in a wellbore annulus 1036, such as shown in FIG. 1, the treatment sub 2000 may be positioned downhole of the lost circulation zone face 1008. The wellbore annulus 1036 is the wellbore 1014 void between the drill string 1026 and the wellbore wall 1022. The wellbore fluid is shown in FIG. 1 flowing 1038 in part through drill bit 1030 and uphole via wellbore annulus 1036. Counter, if the wellbore fluid is circulating downhole through the wellbore annulus, the treatment sub may be positioned uphole of the face of the lost circulation zone. In such an instance, formed LCM would traverse downflow and downhole to the LCZ through the wellbore annulus.

The mud circulation system 1034 is part of drilling system 1018 and serves a number of useful functions during operations, as one of ordinary skill in the art appreciates. A wellbore fluid 1032, such as a drilling fluid or “mud”, circulates in the wellbore 1014 during drilling operations (as well as other types of operations as previously described). The wellbore fluid 1032 typically flows downhole through an internal fluid conduit of the drill string 1026 (as will be described further), out the drill bit 1030, and back uphole through the wellbore annulus 1036. Cuttings and other drilling debris are conveyed from the bottom of the wellbore 1014 uphole. In one or more embodiments, the flow pathway is reversed as previously described.

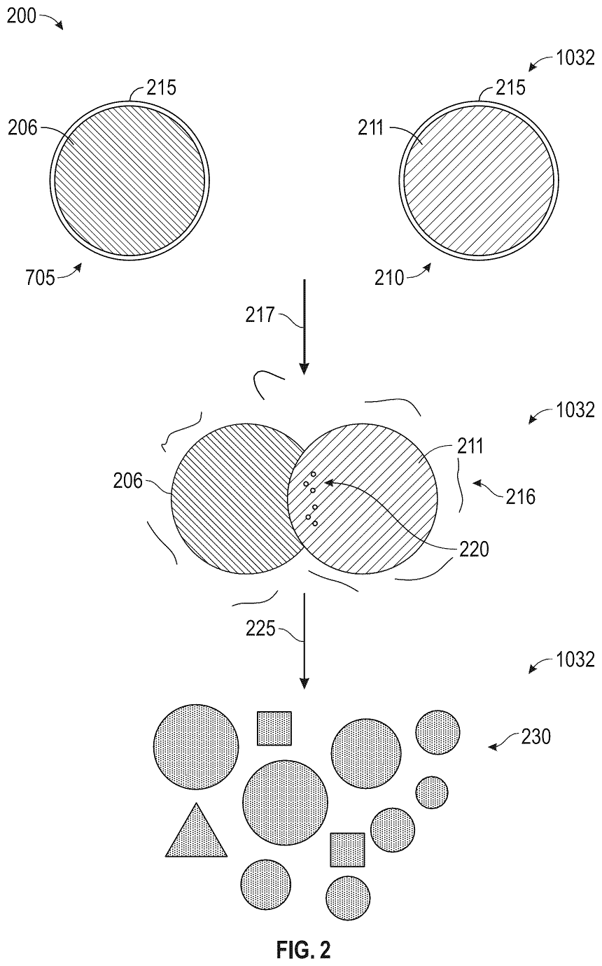

In FIG. 1, several LCM agent capsules 200 (further described as part of FIG. 2) are shown emerging from the drill string 1026 at drill bit 1030, circulating into the wellbore annulus 1036 along wellbore fluid flow 1038 (arrow) and moving uphole towards the lost circulation zone face 1008. As the LCM agent capsules 200 traverse uphole, the LCM agent capsules 200 are shown passing proximate to the treatment sub 2000.

In FIG. 1, the treatment sub in the BHA may be configured with a container sub independent of the treatment sub. In one or more embodiments, the container sub may be used to deliver LCM capsules in the BHA such that the container sub is a delivery sub 1060. In one or more embodiments, the delivery sub may contain LCM capsules. In such embodiments, the LCM capsules may be released from the delivery sub to desired LCZs from the BHA.

Upon reaching the surface 1010, the wellbore fluid 1032 passes into mud receiving tank 1040, where the cuttings and dissolved gases are separated from the wellbore fluid 1032. The degassed wellbore fluid 1032 passes into the mud storage tank 1042, where the wellbore fluid is held until it is pumped back into the drill string 1026. The mud return line 1044, coupled to the mud storage tank 1042 and the drill string 1026, provides the fluid conduit for the wellbore fluid to start the mud circulation cycle again.

Shown in FIG. 1 coupled to mud return line 1044 is an optional LCM agent capsule injection line 1050. LCM agent capsule injection line 1050 fluidly couples optional LCM agent capsule storage tank 1052 to mud return line 1044 such that LCM agent capsules, such as those shown in FIG. 1 as LCM agent capsules 200, may be selectively introduced into the mud circulation system 1034 at the surface 1010.

In one or more embodiments, a well control system 1054 may use information obtained from the operations of the drilling system 1018 in conjunction with a set of pre-determined instructions and algorithms retained in a memory of a computer system to maintain or modify operations of the drilling system 1018, such as the operation of the drill bit 1030 or the treatment sub 2000. In FIG. 1, command signals for maintaining or modifying operations of the drilling system 1018, such as components of the BHA 1029, may be transmitted downhole from well control system 1054 via a control signal line 1046 (dotted line). The well control system 1054 may also maintain or modify operations of the mud circulation system 1034. Control signal lines 1046 may interlink the control system 1054 with support units for the mud storage tank 1042 and the optional LCM agent capsule storage tank 1052, for example, to circulate wellbore fluid and to introduce LCM agent capsules into the wellbore fluid, respectively.

The well control system 1054 may be coupled to a control terminal 1048 to relay information for viewing by an external viewer. The information may be numerically displayed, graphically displayed, or both. An external viewer may include a computer monitor, a television, a printer, or any other form of temporal or permanent version of record keeping, communicating, and displaying that can be visually and audibly appreciated.

Supporting equipment for embodiments of the system may include additional standard components or equipment that enables and makes operable the described apparatuses, processes, methods, systems, and compositions of matter. Examples of such standard equipment known to one of ordinary skill in the art includes, but are not limited to, heat exchanges, blowers, single and multi-stage compressors and pumps, separation equipment, manual and automated control and isolation valves, switches, analogue and computer-based controllers, and pressure-, temperature-, level-, flow-, and other-sensing devices.

### LCM Agent Capsules

In one or more embodiments, the disclosed relates to the formation of a lost circulation material (LCM) useful for mitigating a lost circulation zone (LCZ). In such embodiments, capsules comprising a resin agent that forms a media comprised of a crosslinking agent together, which then may be introduced into the wellbore fluid. Once downhole, the cross-linking agent may be released to initiate crosslinking of the resin, which solidifies to seal the LCZ.

FIG. 2 shows a representation of the interaction between the resin agent and the crosslinking agent. LCM agent capsules 200 may comprise two types of capsules: A resin agent capsule 705 and a crosslinking agent capsule 210. The resin agent capsule 705 comprises a resin agent 206 contained within a shell 215. A crosslinking agent 211 is contained within a shell 215 of the crosslinking agent capsule 210. Both agent capsules 200, 210 in FIG. 2 are shown for effect as distributed within wellbore fluid 1032.

After a capsule shell has been exposed to a useful radiation energy (arrow 217), each of the capsules 705, 210 have had their capsule shell (formerly 215) ruptured or otherwise destroyed, forming several broken shells 216. The broken shells 216 are soft polymer debris or micro/nano-sized solids that pose no potential injury to the wellbore fluid 1032 or mechanical equipment downhole or on the surface.

In FIG. 2, amounts of the resin agent 206 and crosslinking agent 211 are located in proximity to each other in the wellbore fluid 1032. The crosslinking agent is configured to react with the resin agent at downhole conditions. The intimate intermingling and reaction of the two agents (206, 211) forms a solid thermoset polymer material.

During polymerization, a radiation form may be present that influences and encourages acceleration of the polymerization reaction by adding energy into the wellbore environment around the intermingling agents. In exemplary embodiments, the acceleration of the polymerization reaction includes disruption the integrity of a capsule shell, such that the capsule shell may burst or degrade. In such embodiments, destruction of the capsule shell may occur. For example, when magnetic nanoparticles are included in the shell material of the LCM, microcapsule activation may be performed upon exposure to a magnetic radiation, such as an alternating magnetic field. In effect, the shell of the microcapsule may melt under exposure to this form of radiation. Another example of LCM capsule shell activation and disruption is in the presence of electromagnetic radiation. In such embodiments, the electromagnetic radiation may be a microwave radiation. Capsule shells containing microwave susceptible particles, such as carbon nanotubes, may be activated in the microwave radiation, which promotes destruction of the capsule shells.

In one or more embodiments, the form of radiation may further promote turbulent mixing due to cavitation—the formation of bubbles and implosion thereof. Cavitation creates fluidic microjets that have sufficient force to burst the capsule shells and to further mix the wellbore fluid. In addition, increased localized fluid temperature due to heating of the wellbore fluid or the wellbore wall may also occur from the input of a form of radiation. Uneven localized heating may also create convection currents in the wellbore fluid, increasing mixing of the agents.

As the polymerization reaction between the two agents runs to completion (arrow 225), the resultant LCM 230 forms in wellbore fluid 1032. The LCM 230 may comprise various shapes and sizes based upon the amounts and ratios of resin agent and crosslinking agent that react with each other in a given location. Although shown in FIG. 2 as various regular geometric forms, the variety of shapes may be both traditionally geometric and amorphous. As well, the LCM is formed in a distribution of sizes that is a feature in combating various types of lost circulation zones.

In one or more embodiments, a resin agent is introduced into the wellbore fluid. In one or more embodiments, the resin agent is introduced into the wellbore fluid encapsulated in a shell. While the embodiment shown in FIG. 2 depicts the resin agent encapsulated by a shell, the resin agent may not be encapsulated for introduction downhole. The resin agent may be introduced as a liquid in the wellbore fluid with no encapsulation. As such, the resin may still react with the crosslinking agent when it is released from its encapsulation downhole.

The resin agent may be any resin suitable for producing a solid lost circulation material. Such resin agents may react with a crosslinking agent to form an effective, solid LCM product that may withstand the differential pressure as the LCM material bridges the face of the LCZ. In one or more embodiments, the resin may be an epoxy resin.

In one or more embodiments, the resin agent includes an epoxide resin. Generally, such epoxide resins are derived from a polyether derivative of a polyhydric organic compound, where the derivation includes a 1,2-epoxy groups and where the polyhydric organic compound includes polyhydric alcohols, polyhydric phenols, and ethers that contain at least two phenolic hydroxy groups.

Polyhydric phenols for deriving useful epoxide resins include, but are not limited to, mononuclear phenols, such as, but not limited to, resorcinol, catechol, hydroquinone; polynuclear phenols, such as, but not limited to, bis(4-hydroxyphenyl)-2,2-propane (bisphenol-A), 4,4′-dihydroxybenzophenone, bis(4-hydroxyphenyl)-1,1-ethane, bis(4-hydroxyphenyl) 1,1-isobutane, bis(4-hydroxyphenyl)-2,2-butane, bis(4-hydroxy-Z-methylphenyl)-2,2-propane, bis(4 hydroxy-Z-tertiary butylphenyl)-2,2-propane, bis 4′ hydroxy-2,5-dichlorophenyl)-2,2-propane, 4,4′-dihydroxybiphenyl, 4,4-dihydroxy-pentachlorobisphenyl, bis(2 hydroxynaphthyl)-methane, 1,5-dihydroxy naphthalene, phloroglucinol, 1,4-dihydroxynaphthalene, and 1,4-bis(4-hydroxyphenyl) cyclohexane; and complex polyhydric phenols, such as, but not limited to, pyrogallol and phloroglucinol.

Aliphatic polyhydric alcohols for deriving useful epoxide resins include, but are not limited to, ethylene glycol, propylene glycol, trimethylene glycol, triethylene glycol, butylene glycol, diethylene glycol, 4,4-dihydroxydicyclohexyl, glycerol, and dipropylene glycol. Alcohols with more than one hydroxyl group are useful for deriving epoxide resins.

Ethers for deriving useful epoxide resins include, but are not limited to, glycerol, mannitol, sorbitol, polyallyl alcohol, and polyvinyl alcohol. Such glycidyl polyethers also have a 1,2-epoxy value greater than 1.0.

In one or more embodiments, the epoxide resin may comprise a novolacs resin, bisphenol-based resins, aliphatic resins, halogenated resins, glycidilamine resins, or reactive diluent.

In one or more embodiments, the resin agent further includes a co-epoxide resin. The co-epoxide resin may be any of the previously described resins or epoxide resins derived from the previously described resin precursors. Useful co-epoxide agents include, but are not limited to, bisphenol-A-epichlorohydrin epoxy resin with the reactive diluent oxirane mono [(C12-C14)-alkyloxy) methyl] derivatives; C12-C14 alkyl glycidyl ether; 2,3-epoxypropyl-o-tolyl ether; 1,6-hexanediol diglycidyl ether; bisphenol A/epichlorohydrin resin and butyl glycidyl ether resin; bisphenol A/epichlorohydrin and butyl glycidyl ether and cyclohexanedimethanol resins; and cyclohexanedimethanol diglydicyl ether. Such co-epoxy agents may be useful for modifying the physical or chemical properties of the product LCM versus a formed LCM without the co-epoxy agent, for example, by increasing or decreasing elasticity of the thermoset material or increasing or decreasing swelling at wellbore conditions.

In one or more embodiments, the resin agent may further comprise micro or nano-sized particles susceptible to magnetic radiation. In such an instance, the magnetic-susceptible particles may damage or destroy the integrity of the shell in reaction to exposure to the magnetic radiation of the radiation treated area.

In one or more embodiments, a crosslinking agent is introduced into the wellbore fluid. In one or more embodiments, the crosslinking agent is introduced into the wellbore fluid encapsulated in a capsule shell.

The crosslinking agent may be any crosslinking agent suitable for producing a solid lost circulation material. As previously described, such crosslinking agents are configured to react with the resin agent to form an LCM product. In one or more embodiments, the crosslinking agent may also be configured to react with the co-epoxy agent at downhole conditions in the wellbore fluid.

In one or more embodiments, the crosslinking agent is an amine type curing agent. Amine type curing agents may include a low molecular weight compound having a primary-, secondary-or tertiary amino group, and combinations thereof. “Low molecular weight” compounds having a primary amino group include, but are not limited to, primary amines, such as ethylenediamine, diethylenetriamine (DETA), triethylenetetramine, tetraethylenepentamine, hexamethylenediamine, isophorone diamine, bis(4-amino-3-methylcyclohexyl) methane, diaminodicyclohexylmethane, m-xylenediamine, diaminodiphenylmethane, diaminodiphenylsulfone, diethyltoluenediamine, polyoxypropylene diamine, and m-phenylenediamine; guanidines, such as dicyandiamide, methylguanidine, ethylguanidine, propylguanidine, butylguanidine, dimethylguanidine, trimethylguanidine, phenylguanidine, diphenylguanidine, and toluylguanidine; acid hydrazides, such as succinic acid dihydrazide, adipic acid dihydrazide, phthalic acid dihydrazide, isophthalic acid dihydrazide, terephthalic acid dihydrazide, p-hydroxybenzoic acid hydrazide, salicylic acid hydrazide, phenylaminopropionic acid hydrazide, and maleic acid dihydrazide.

Low molecular weight compounds having a secondary amino group include, but are not limited to, piperidine, pyrrolidine, diphenylamine, 2-methylimidazole, and 2-ethyl-4-methylimidazole.

Low molecular weight compounds having a tertiary amino group include, but are not limited to, imidazoles, such as 1-cyanoethyl-2-undecylimidazole-trimellitate, imidazolylsuccinic acid, 2-methylimidazole-succinic acid, 2-ethylimidazole-succinic acid, 1-cyanoethyl-2-methylimidazole, 1-cyanoethyl-2-undecylimidazole, and 1-cyanoethyl-2-phenylimidazole.

In one or more embodiments, the crosslinking agent may further comprise micro- or nano-sized particles susceptible to magnetic radiation. In such an instance, the magnetic-susceptible particles may damage or destroy the integrity of the shell upon exposure to the magnetic radiation of the radiation treated area.

In one or more embodiments, the resin agent, the crosslinking agent, or both may each separately be encapsulated by a capsule shell. The capsule shell is a barrier with a surface that defines an interior void in which the resin agent or the crosslinking agent is present. The capsule shell encapsulates the contained fluid or solid, and the contained fluid or solid is separated from other fluids, such as its associated agent or a wellbore fluid.

The capsule shell is configured to rupture or disassociate upon exposure to an appropriate source of radiation. The shell may be ruptured directly by the radiation acting upon the capsule shell, the shell agent, or the fluid contained within. The shell may also be ruptured by the microfluid jets within the wellbore fluid impacting the surface of the capsule shell and damaging or disintegrating the capsule shell. Through either mechanism, or both, or others, once the capsule shell is ruptured, the contained agent is exposed to the wellbore fluid and, potentially, its associated counteragent.

In one or more embodiments, the resin agent is not encapsulated. In such embodiments, the resin agent may be introduced into the wellbore fluid without a shell. In such an instance, the only LCM agent capsules introduced into the wellbore fluid are crosslinking agent capsules.

“Micro-sized” is defined as having an average dimension, such as a diameter (sphere), a diagonal (cube, prism), or an average of a length and a diameter (ellipsoid) in a range of from about 100 micrometers (μm) to about 100 nanometers. “Nano-sized” is defined similarly in a range of from about 100 nanometers (nm) to 1 nanometer.

In one or more embodiments, the capsule shell may further comprise micro-or nano-sized particles that are susceptible to magnetic radiation. For example, a polymer shell may further comprise particles susceptible to magnetic radiation. In such an instance, the capsule passing through a radiation treated area having a magnetic component, the magnetic-susceptible particles encountering one or more forms of magnetic radiation within the radiation treated area may sheer and destroy the polymer shell as they react to changes to the magnetic field within the wavefield. In other instances, the magnetic radiation may cause the magnetic-susceptible particles to vibrate and obtain an elevated temperature, which may cause the polymer shell to soften (transition through a glass-transition temperature for a thermoplastic polymer material), to flow (transition through a melt-transition temperature for a thermoplastic polymer material), or to chemically degrade (transition through a polymer degradation temperature), thereby disrupting the integrity of the capsule surface.

In one or more embodiments, the thickness of the capsule shell may be in a range of from about 500 nm to 10 μm.

The capsule shell is configured such that the capsule shell is operable to withstand the wellbore conditions, including elevated temperatures, elevated pressure, and elevated salinity. “Elevated” in the context of temperature and pressure means greater than room temperature and pressure, respectively. “Elevated” in the terms of salinity means greater than the salinity of fresh water, such as one of ordinary skill would expect for a brine, many wellbore fluids, a brine, or formation water.

The capsule shell may be made of a resin agent. The resin agent may be configured to encapsulate the cross-linking agent. The capsule shell may also be made of a shell agent. The shell agent used to encapsulate the resin agent, the crosslinking agent, or both separately, is not configured to react or otherwise neutralize the contained agent from its purpose of forming LCM upon reaction with its associated counter material. The shell agent does not prevent the contained agent from being released upon exposure to an appropriate form of radiation.

In one or more embodiments, the resin agent and the crosslinking agent are encapsulated using capsule shell comprising the same shell agent. In one or more embodiments, the resin agent and the crosslinking agent are encapsulated using capsule shell comprising different shell agents.

In one or more embodiments, the shell agent useful for encapsulation may comprise a polymeric material. Useful types of polymeric materials may include, but are not limited to, melamine-formaldehyde, urea-formaldehyde, phenol-formaldehyde, melamine-phenol-formaldehyde, furan-formaldehyde, epoxy, polysiloxane, polyacrylate, polyester, polyurethane, polyamide, polyether, polyimide, polyolefin, polypropylene- polyethylene copolymers, polystyrene, functionalized polystyrene derivatives, gelatin, gelatin derivatives, cellulose, cellulose derivatives, starch, starch derivatives, polyvinyl alcohol, ethylene-vinylacetate copolymers, maleic-anhydride based copolymers, polyacrylamide, polyacrylamide based copolymers, polyacrylic acid, polyacrylic acid based copolymers, polyvinylpyrrolidone, polyvinylpyrrolidone based copolymers, polyacrylate based copolymers, polyacrylamide, polyacrylamide based copolymers, propylene-acrylate copolymers, propylene-methacrylate copolymers, oxidized polypropylene, oxidized polyethylene, propylene-ethylene oxide copolymers, styrene-acrylate copolymers, and acrylonitrile-butadiene-styrene copolymers.

The agent capsule containing either crosslinking agent or resin agent are configured to be buoyant in the wellbore fluid for which they are introduced into, as one of ordinary skill would appreciate. In one or more embodiments, the specific gravity of the capsules to the mud may be from approximately 0.8 to 1.2. In one or more embodiments, the diameter of the product LCM is in a range of from about 1 μm to 5 millimeters. In one or more embodiments, the diameter of an agent capsule is in a range of from about 0.5 μm (micrometer) to 1000 μm, such as in a range of from about 1 μm to 500 μm.

### Treatment Sub

In one or more embodiments, a treatment sub is introduced into a wellbore and positioned proximate to a face of a lost circulation zone. The treatment sub may be introduced as part of a treatment system.

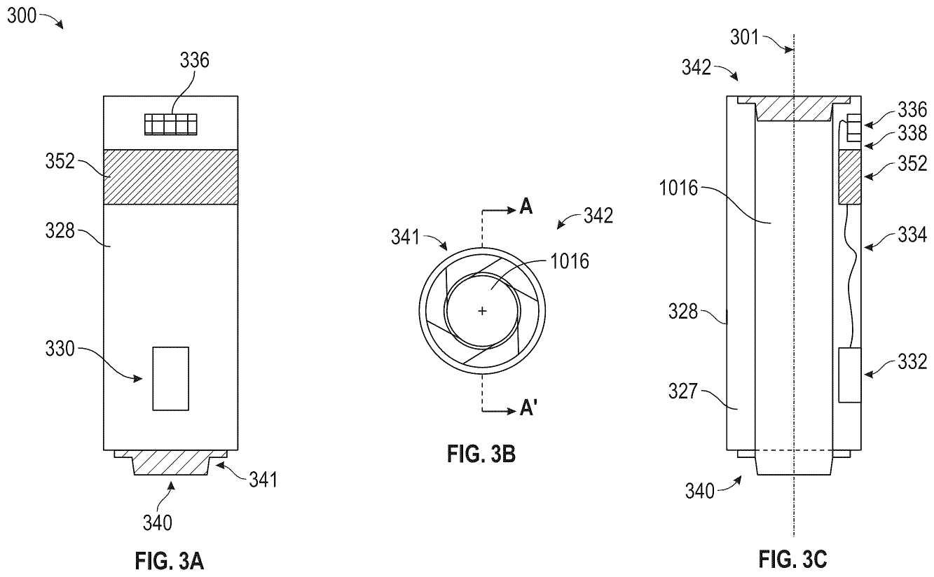

FIGS. 3A-C show an exterior front, a top, and a partial side internal view of a treatment sub. FIG. 3A shows the exterior front of the treatment sub 300, which provides for a view of an exposed male connector 340 with connector threads 341, a front portion of a radiation source 352 for generating sustained radiation with in a wellbore, a front portion of an external communication device 336 for receiving an external communication from the surface, and a power supply cover 330, which acts as an external yet fluid-tight access port for an on-board power source to be described.

FIG. 3B shows a top-down view of the treatment sub 300, where the internal fluid conduit 1016, which may act as a continuation of an internal fluid conduit the drill string 1026 (FIG. 1), is seen in the center. Female connector 342, the inverse coupling connector to male connector 340, along with threads 341, are also present.

Bifurcation view line A-A′ of FIG. 3B provides the partial side internal view for FIG. 3C. Portions of both connectors 340, 342 are visible with threads 341 visible on the female connector 342. A treatment sub longitudinal axis 301 is provided that bisects lengthwise the treatment sub 300 and runs parallel with the internal fluid conduit 1016. The sub interior 327 is visible between the internal fluid conduit 1016 and the sub exterior surface 328 of the treatment sub 300. A portion of the radiation source 352 is provided within the sub interior 327 in the uphole portion.

In one or more embodiments, the radiation source may be a particle radiation source, such as a neutron radiation source, alpha radiation source, beta radiation source, and combinations thereof. In such embodiments, a power supply may not be required. In embodiments that include a form of radiation that may require a power source, such as an electromagnetic radiation source, an onboard battery may be included. The onboard battery 332 is coupled and provides power to the radiation source 352 using power coupling 334. Power coupling 334 acts as a power conduit from the onboard battery 332 to radiation source 352. The external communication device 336 is shown coupled to radiation source 352 through signal coupling 338.

There are several alternative options for providing power to a radiation source of a treatment sub. As previously described, the treatment sub may have an onboard battery that provides powers to one or more wavefield sources. In some configurations, there may be a battery unit that is a separate part of the BHA that is electrically coupled to the treatment sub that provides power. Another option is a “mud motor” that may be used to convert flow energy of the wellbore fluid passing through the internal fluid conduit of the BHA into electrical power. An electrical conduit optionally coupled to a power source at the surface, such as a generator or a utility line, may be used to provide power directly to the wavefield source. Other options are available and are appreciated by one of ordinary skill in the art. Other options are available and are appreciated by one of ordinary skill in the art.

Several options known to those of skill in the art are feasible for communicating with the treatment sub. As shown in FIGS. 3A and 3C, an external communication device 336 for receiving an external communication is shown positioned onboard. Ways of maintaining communications with the treatment sub include, but are not limited to, a dedicated communication line from the surface coupled to an internally-located communications device, such as control signal line 1046 of FIG. 1, mud telemetry through the wellbore fluid 1032 to an externally-located communication device, and by “smart pipe”, a form of drill pipe with integrated electrical and signal connectors, that may couple with similar integration at the drill pipe connector. Other forms of providing communications to and from the treatment sub, such as mud telemetry and wired pipe, are appreciated by one of skill in the art.

As shown in FIGS. 3A-C, a treatment sub may have a single radiation source. In one or more embodiments, the radiation source may generate at least a single form of radiation. In such an embodiment, non-limiting examples of the radiation source may be a source of neutron radiation, alpha radiation, beta radiation, gamma radiation, X-ray radiation, ultraviolet-visible radiation, and combinations thereof.

In one or more embodiments, the radiation source may generate an electromagnetic type of radiation. In one or more embodiments, the form of radiation may be a gamma radiation. In such embodiments, a single frequency may range from about 10¹⁹ to 10²⁰ Hz. In one or more embodiments, the form of radiation may be an X-ray radiation, where the single frequency may range from about 10¹⁷ to 10¹⁹ Hz. Alternatively, ultraviolet radiation may be used, which may have a single frequency from about 7.5×10¹⁴ to 7.5×10¹⁶ Hz. In one or more embodiments, the radiation source may generate a visible form of radiation, which may include a single frequency from about 4×10¹⁴ to 8×10¹⁴ Hz. In an exemplary embodiment, the generated radiation may be below the visible range. In such an embodiment, the frequency may be in a range from about 50 kHz to 1500 kHz range.

In one or more embodiments, a radiation source may be configured to generate a particle radiation. In such embodiments, the particle radiation may be a neutron radiation, alpha radiation, gamma radiation, and combinations thereof. The particle radiation may produce a form of particle radiation in a single absorbed dose range of about 1 kGy to 200 kGy (kiloGray) or above. Palpable capsule shell degradation effects may be observed in a range of 10 kGy to 150 kGy. In exemplary embodiments, palpable degradation may occur between 10 to 100 kGy or from 50 to 150 kGy.

In one or more embodiments, the radiation source is configured to generate multiple forms of radiation simultaneously. For example, a single radiation source may generate a plurality of forms of radiation. For example, an electromagnetic radiation source may be configured to generated multiple desired peak frequencies. In such instances, a plurality of electromagnetic responsive LCM capsules will be excited and activate LCM protocols. In some embodiments, a plurality of radiation sources may be configured such that a plurality of forms of radiation may be generated simultaneously.

In one or more embodiments, the radiation source may be configured to generate a single form of radiation. However, as is understood by those skilled in the art, even a single form of radiation generally includes a narrow range of radiation. Thus, as used herein, “a single form of radiation” generally refers to a narrow spectrum of radiation. In one or more embodiments, the radiation source is configured to generate a single form of radiation at multiple energy levels. In one or more embodiments, the radiation source is configured to generate a single form of radiation at multiple energy levels sequentially. For example, the radiation may generate an electromagnetic radiation comprised of a first single frequency during a first period and then alternate to a second single frequency during a second period. In one or more embodiments, the radiation source is configured to generate multiple forms of radiation simultaneously. In such configurations, the periods may be very short to cause oscillations in the patterns in the wavefield. In one or more embodiments, a plurality of radiation sources may be included and configured in the BHA system to provide the plurality of forms of radiation. In one or more embodiments, a single radiation generator may be configured to generate an array of forms of radiation such that the generated forms of radiation may be an electromagnetic radiation and a particle generation.

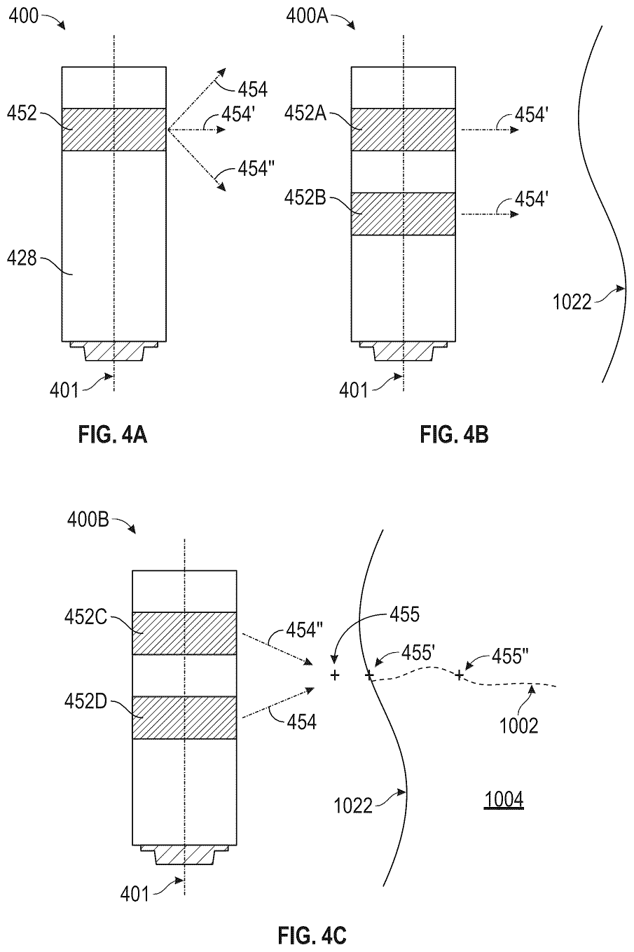

FIGS. 4A-C show several configurations of a treatment sub. FIG. 4A shows a treatment sub 400 similar to that of treatment sub 300; however, the radiation source 452 may be configured differently than radiation source 352. The radiation source 452 is shown being positioned in potentially several different configurations such that the generated form of radiation is directed in one of several directions away from the radiation source 452, including in an uphole direction 454, a normal direction 454′, and a downhole direction 454″. The directions are appreciated given the non-perpendicular angles to the treatment sub longitudinal axis 401 in the case of uphole direction 454 and downhole direction 454″ and at a right angle to the treatment sub longitudinal axis 401 for the normal direction 454′. The selected configuration of a radiation source and direction of a generated form of radiation will be determined by such factors as the experience of the person of ordinary skill in the art and the need to remedy the problem of lost circulation zones.

FIG. 4B shows a different configuration of treatment sub 400—treatment sub 400A. FIG. 4B shows that a treatment sub may have more than one radiation source, for example, treatment sub 400A has both a first radiation source 452A and a second radiation source 452B. Similar to what was previously described, each of the radiation sources may be configured such that the wavefields generated are directed away from the treatment sub, such as toward a wellbore wall.

Each radiation source may be configured to direct a generated frequency independently of or in coordination with another radiation source. In one or more embodiment, a plurality of radiation sources may be configured such that a plurality of generated forms of radiation may not intersect. In the example provided for regarding treatment sub 400A, both radiation sources 452A, 452B are configured such that the generated forms of radiation produced are directed normally 454′ towards wellbore wall 1022. With this configuration, the generated forms of radiation from radiation sources 452A, 452B are directed such that they are effectively parallel to one another. Because of the distance between the sub exterior surface 428 of the treatment sub 400A and a surface, such as a wellbore wall 1022 as given in FIG. 4B, the generated frequencies directed in a normal direction 454′ may not intersect before reaching the wellbore wall 1022. In other instances, the generated frequencies may be intentionally directed away from one another, that is, the configuration of one radiation source directs a first generated energy uphole or downhole and another radiation source directs a second generated energy in a non-intersecting direction. In other instances, the generated forms of radiation may not intersect before the energy within the wavefields are expended, for example, within the subsurface formation. The forms of radiation possess a finite amount of energy that is depleted as the wavefield travels from the radiation sources.

In one or more embodiments, a plurality of radiation sources may be configured such that at least some of the plurality of generated forms of radiation intersect within the annulus of a wellbore. In one or more embodiments, a plurality of radiation sources may be configured such that a plurality of generated energies may intersect at a wellbore wall. In one or more embodiments, a plurality of radiation sources may be configured such that a plurality of generated forms of radiation may intersect within a subterranean formation. FIG. 4C shows treatment sub 400B with a first and second radiation sources 452C, 452D, respectively. The first and second radiation sources 452C, 452D are configured such that their respective generated forms of radiation intersect one another at a directed wavefield transmission intersection point. For example, radiation source 452C is configured such that a generated form of radiation is directed in a downhole direction (454″); radiation source 452D is configured such that a generated form of radiation is directed in an uphole direction (454). In such an instance, the generated forms of radiation may be directed to intersect at a point 455 (designated by an “+”) within the wellbore annulus. In other instances, the generated forms of radiation may be directed to intersect at a point 455′ that coincides with the wellbore wall 1022. In yet other instances, the generated frequencies may be directed to intersect at a point 455″ within a subsurface formation 1004, which is well beyond the wellbore wall 1022. In some such instances, the intersection point 455″ may be proximate to a portion of a lost circulation zone 1002 to encourage LCM formation within the lost circulation zone 1002 itself.

In one or more embodiment, a plurality of radiation sources may be configured such that the plurality of generated forms of radiation may comprise the same or similar type of radiation. For example, the first radiation sources 452A and 452C and the second radiation sources 452B and 452D of FIGS. 4B and 4C, respectively, may be configured essentially the same but for direction of transmission of their respective generated forms of radiation, as previously described. Upon generation of the same (for example, two electromagnetic) or a similar (for example, one gamma and another neutron) type of forms of radiation, the LCM agent capsules may experience prolonged exposure to the generated forms of radiation, such as the configuration shown in FIG. 4B, as the capsules traverse up the wellbore annulus and through the fields. In other instances, such as the configuration of FIG. 4C, where the generated forms of radiation overlap, a greater radiative intensity or a synergy may be present in the wellbore annulus. Because the forms of radiation are being produced at different positions along the body of the treatment sub 400B and are being directed in different directions, the exposure of the capsules to the intersecting forms of radiation may subject the capsules to greater pressure or frequency intensity even for a short duration of time. This exposure may be sufficient to, for example, affect nano-or micro-sized particles, which may increase local temperatures, vibrational movements, and disrupt the shell of the LCM agent capsules.

In one or more embodiments, the configuration of the transmission sub permits the formation of a standing type of radiation within the wellbore fluid. In one or more embodiments, travelling types of radiation may be generated using instruments such as an acoustic tweezer. Acoustic tweezers may generally be used to concentrate LCM capsules and move them to desired locations using acoustic waves at given frequencies. In such embodiments, the LCM capsules may be susceptible to electromagnetic radiation such that electromagnetic manipulation may be used to concentrate LCM capsules.

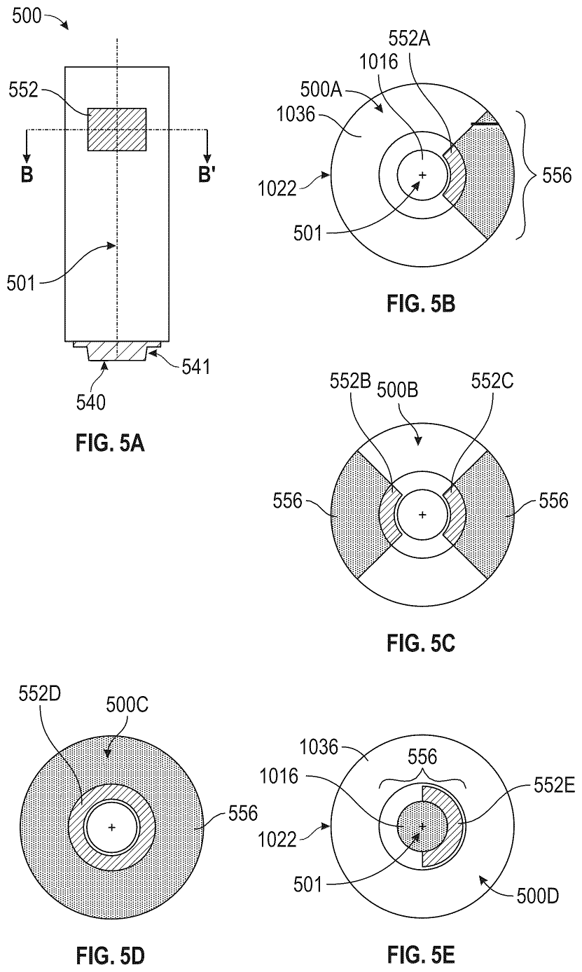

FIGS. 5A-E show several configurations of a treatment sub. As with previously described configurations of treatment subs, treatment sub 500 has similar features to treatment subs 400 and 300, such as longitudinal axis 501. One may note that the radiation source 552 appears reduced comparatively with previously described treatment subs.

Bifurcation view line B-B′ of FIG. 5A provides the partial top-down internal view for FIG. 2. In this case, radiation source 552A is shown within treatment sub 500A facing outward towards wellbore wall 1022 as if in a wellbore. A portion of the wellbore annulus 1036 ring is shown as being shaded in the area between the radiation source 552A and the wellbore wall 1022. The shaded treatment area 556 of the wellbore annulus 1036 represents the transmission area of the radiation source 552A—where the form of radiation is present during radiation generation. A form of radiation is generated from the radiation source 552A outward towards the wellbore wall 1022 during treatment.

The treatment area may be described in relative terms of the total (cross-sectional) area of the wellbore annulus at the position of the wellbore where the radiation source is present. The plane of such a cross-sectional area of the wellbore annulus would be normal to the longitudinal axis of the treatment sub. For example, in FIG. 5A, it appears that about 25% of the area of the wellbore annulus 1036 comprises treatment area 556. In such a circumstance, during a period of radiation generation by the treatment sub 500A, about 25% of the cross-sectional area of the wellbore annulus 1036 will have an active form of radiation between the radiation source 552A of the treatment sub 500A and the wellbore wall 1022.

Bifurcation view line B-B′ of FIG. 5A also provides the partial top-down internal view for FIG. 5C. As shown in FIG. 5C, two radiation sources—first radiation source 552B and second radiation source 552C—of treatment sub 500B, also shown as 540 and 541 of FIG. 5A, respectively, appear to act in concert to generate two separate yet similar forms of radiation. Combined, the two shaded areas appear to encompass about 50% of the area of the wellbore annulus 1036 to comprise the treatment area 556.

Bifurcation view line B-B′ of FIG. 5A also provides the partial top-down internal view for FIG. 5D. FIG. 5D appears to show a single radiation source 552D for treatment sub 500C able to provide complete wellbore annulus coverage. The entire cross-sectional area of the wellbore annulus 1036 at that position in the wellbore comprises the treatment area 556.

The term “total” means 100% of the overall value of something by the stated unit of measure (for example, area, mass, volume, mole). The term “majority” means greater than 50.00% but less than 100% that is, less than totality) of the overall value of something by the stated unit of measure. The term “substantial” means greater than 10.00% but less than or equal to 50.00% (that is, less than a majority) of the overall value of something by the stated unit of measure. The term “significant” means greater than 1.00% but less than or equal to 10.00% (that is, less than substantial) of the overall value of something by the stated unit of measure. The term “detectable” means equal to or greater than 0.01% but less than or equal to 1.00% (that is, less than significant) of the overall value of something by the stated unit of measure. The term “incidental” means less than 0.01% of the overall value of something by the stated unit of measure. However, “incidental” does not exclude something; rather, the term indicates that if determined to be present using industry-available analytical equipment its presence may be considered is de minimus for the purposes of this application.

In one or more embodiments, the treatment sub is configured such that the treatment area is the total cross-sectional area of the wellbore annulus. In one or more embodiments, the treatment sub is configured such that the treatment area is a majority of the cross-sectional area of the wellbore annulus. In one or more embodiments, the treatment sub is configured such that the treatment area is a substantial cross-sectional area of the wellbore annulus. In one or more embodiments, the treatment sub is configured such that the treatment area is a significant cross-sectional area of the wellbore annulus. In one or more embodiments, the treatment sub is configured such that the treatment area is a detectable cross-sectional area of the wellbore annulus. In one or more embodiments, the treatment sub is configured such that the treatment area is an incidental cross-sectional area of the wellbore annulus. In one or more embodiments, the treatment area is in a range of from about 0.1 to 100% of the cross-sectional area of the wellbore annulus.

Bifurcation view line B-B′ of FIG. 5A also provides the partial top-down internal view for FIG. 5E. FIG. 5E shows a version of the treatment sub 500D where there is a single radiation source 552E that is directed inwards towards the internal fluid conduit 1016 of the treatment sub 500D. No portion of the wellbore annulus 1036 appears treated by treatment sub 500D, but the entirety of the internal fluid conduit 1016 appears within the treatment area 556. Such a configuration—where the radiation source is configured such that the generated frequency is directed inward into the internal fluid conduit—may require less energy yet be more powerful since the wavefield transmission is through a relatively reduced area (the internal fluid conduit cross-sectional area versus the wellbore annulus cross-sectional area).

In one or more embodiments, the treatment sub is configured such that the treatment area is the total cross-sectional area of the internal fluid conduit. In one or more embodiments, the treatment sub is configured such that the treatment area is a majority of the cross-sectional area of the internal fluid conduit. In one or more embodiments, the treatment sub is configured such that the treatment area is a substantial cross-sectional area of the internal fluid conduit. In one or more embodiments, the treatment sub is configured such that the treatment area is a significant cross-sectional area of the internal fluid conduit. In one or more embodiments, the treatment sub is configured such that the treatment area is a detectable cross-sectional area of the internal fluid conduit. In one or more embodiments, the treatment sub is configured such that the treatment area is an incidental cross-sectional area of the internal fluid conduit. In one or more embodiments, the treatment area is in a range of from about 0.1 to 100% of the cross-sectional area of the internal fluid conduit.

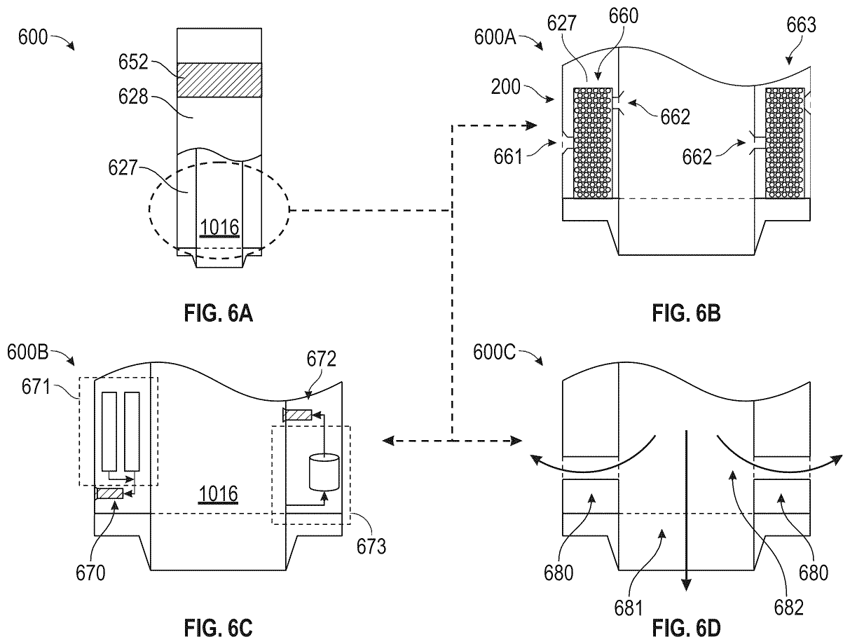

FIGS. 6A-D show in partial reveal several optional configurations of a treatment sub. Treatment sub 600 in FIG. 6A is shown with radiation source 652 similar to prior described treatment subs 300, 400, and 500. The treatment sub 600 is shown in partial reveal in the downhole portion such that a portion of the sub interior 627 is visible along with the internal fluid conduit 1016.

In the partial reveal feature of FIG. 6B, several optional configurations for agent capsule containers are shown. The treatment sub 600A shows an agent capsule container 660 positioned in the sub interior 627, where the sub exterior is 628. In one or more embodiments, the agent capsule container 660 may be selectively fluidly coupled to the exterior of the treatment sub 600A using externally directed capsule conduit 661. The externally directed capsule conduit permits selective distribution LCM agent capsules from the agent capsule container into a fluid exterior to the treatment sub, such as into a wellbore fluid in a wellbore annulus. In one or more embodiments, the agent capsule container 660 may be selectively fluidly coupled to the interior of the treatment sub 600A using internally directed capsule conduit 661. The internally directed capsule conduit permits selective distribution of LCM agent capsules from the agent capsule container into a wellbore fluid present in the interior fluid conduit. In one or more embodiments, the treatment sub may have both externally directed 661 and internally directed 662 capsule conduits to provide maximum selectivity in distributing LCM agent capsules positioned downhole.

The agent capsule container may contain one or more types of LCM agent capsules. In one or more embodiments, the agent capsule container may contain a plurality of LCM agent capsules. In such an embodiment, the plurality of LCM agent capsules are only resin agent capsules. In other such embodiments, the plurality of LCM agent capsules are only crosslinking agent capsules. In yet other embodiments, the plurality of LCM agent capsules are a combination of both resin agent capsules and crosslinking agent capsules.

In one or more embodiments, the treatment sub may be fitted with a plurality of agent capsule containers. For example, the treatment sub 600A is shown with an agent capsule container 660 and a second agent capsule container 663. In one or more embodiments, each agent capsule container contains the same mixture of resin agent capsules and crosslinking agent capsules. This may permit multiple treatments for multiple detected LCZs. In one or more embodiments, each capsule container contains a different type of LCM agent capsule. Such a configuration may permit a single yet massive distribution of LCM agent capsules downhole in an attempt to halt a detected LCZ. Other configurational and operational aspects of the plurality of the agent capsule containers, such as where each container distributes capsules, size of each agent capsule container, mix of LCM agent capsules, and coordination or lack thereof in distributing LCM agent capsules with other agent capsule containers, is at the discretion of a person of ordinary skill.

In the partial reveal feature of FIG. 6C, several optional configurations for bubble generation systems are shown. The treatment sub 600B shows two example bubble generating systems positioned in a part of the sub interior 627 for generating bubbles downhole. In the first example system, a chemical reaction system 671 (dashed box) is represented by a plurality of containers. The chemical reaction system is positioned within the sub interior 627 and is configured to generate a compressible gas product downhole. These containers may contain a two-part chemical system that when the two components are mixed—such as an ammonium-containing compound and a nitrite-containing compound—a compressible gas product, such as nitrogen, is produced. Other variations, such as a single chemical that degrades at a specific temperature or pH, are known to one of skill in the art and are appreciated.

In the second example system provided for with treatment sub 600C, an electrochemical system 673 is shown. The electrochemical system is positioned within the sub interior 627 and is configured to generate a compressible gas product utilizing the wellbore fluid. In electrochemical system 673 of FIG. 6C, wellbore fluid from the internal fluid conduit 1016 is drawn into an electrochemical cell, where ionic species, such as salts or water, are separated electrochemically into a compressible gas product, such as hydrogen, oxygen, or chlorine. In one or more embodiments, the electrochemical system may be configured such that wellbore fluid may be drawn from the exterior of the treatment sub 600B, such as from the wellbore annulus.

An externally directed bubble generator 670 is positioned downstream of and fluidly coupled to the chemical reaction system 671. The externally directed bubble generator 670 not only is configured to transform the produced compressible gas product from the chemical reaction system into bubbles but also to direct the bubbles to the exterior of treatment sub 600B, such as into the wellbore annulus. In one or more embodiments, the chemical reaction system may be fluidly coupled to an internally directed bubble generator, such as internally directed bubble generator 672. The compressible gas products for the electrochemical system 673 are passed through internally directed bubble generator 672, where the compressible gas products are converted into bubbles and introduced into the wellbore fluid in the internal fluid conduit 1016 of the treatment sub 600C. In one or more embodiments, the electrochemical system may be fluidly coupled to an externally directed bubble generator.

In one or more embodiments, an additional material may be released from the treatment sub downhole. In such configurations, the additional material may be an agent that catalyzes the cross-linking reaction of the LCM. The additional material may also be configured to delay progression of the cross-linking reaction of the LCM.

In the partial reveal feature of FIG. 6D, a plurality of capsule conduit bypasses 680 are shown. A capsule conduit bypass 680 selectively fluidly connects the internal fluid conduit through the sub exterior surface 628 to the exterior of the treatment sub 600C, such as to a wellbore annulus. A portion of the main fluid flow 681 and 682 (arrows) traversing downhole bypasses the remainder of the BHA, including the drill bit, and is diverted through the capsule conduit bypass 680 into the volume exterior to the treatment sub 600C. Although not shown for the sake of clarity, the capsule conduit bypass 680 is configured such that the fluid flow from the interior fluid conduit to the exterior of the treatment sub is selective, that is, the capsule conduit bypass may be operated such that the capsule conduit bypass is fully open, partially opened (that is, flow is throttled), or fully closed (that is, there is no fluid communication through the capsule conduit bypass). In such embodiments, the capsule conduit bypass may be operated using a ball-activated drilling circulating valve. The ball-activated drilling circulating valve may be operated to fully open the conduit bypass, partially open the conduit bypass, or fully close the conduit bypass as described above.

As one of ordinary skill may appreciate, none, some, or all of these optional features and others not specifically described here may be combined as part of a treatment sub for use in mitigating a lost circulation zone. As well, one of ordinary skill may also appreciate there are variations to such systems that are envisioned and appreciated.

### Modified Wellbore Fluid

One or more embodiments may include a modified wellbore fluid. The modified drilling wellbore comprises a wellbore fluid along with the previously described resin agent and the crosslinking agent.

The “wellbore fluid” is a wellbore service fluid, that is, a fluid used to drill (a “drilling fluid”), complete, work over, or in any way useful to service a well bore. For example, the wellbore fluid may serve as a drilling fluid, a completion fluid, a work-over fluid, a gravel packing fluid, a formation fracturing fluid, a stimulating fluid, or a packer fluid. Other types of fluids for which the wellbore fluid may be used would be apparent to one skilled in the art. The concentration of each component in the wellbore fluid depends upon the intended use of the wellbore fluid. For the purposes of this application, the terms “wellbore fluid” and “drilling fluid” are used interchangeably.

In one or more embodiments, a wellbore fluid includes an aqueous-based fluid. The aqueous-based fluid includes water. The water may be distilled water, deionized water, tap water, fresh water from surface or subsurface sources, production water, formation water, natural and synthetic brines, brackish water, natural and synthetic sea water, black water, brown water, gray water, blue water, potable water, non-potable water, other waters and combinations thereof that are suitable for use in a wellbore environment, that is, the contaminants do not interfere with the function of the drilling fluid. In one or more embodiments, the water used may naturally contain contaminants, such as salts, ions, minerals, organics, and combinations thereof, as long as the contaminants do not interfere with the function of the drilling fluid.

The wellbore fluid may contain water in a range of from about 50 to 97 wt % (weight percent) based on the total weight of the wellbore fluid. In one or more embodiments, the embodiment wellbore fluid may comprise greater than 70 wt % water based on the total weight of the wellbore fluid.

In one or more embodiments, the water used for the wellbore fluid may have an elevated level of salts or ions versus fresh water, such as salts or ions that are naturally present, such as in formation water, production water, seawater, and brines. In one or more embodiments, salts or ions are added to the water used to increase the level of a salt or ion in the water to effect certain properties, such as density of the wellbore fluid or to mitigate the swelling of clays that come into contact with the wellbore fluid, such as in “synthetic” brines and seawaters. Without being bound by any particular theory, increasing the saturation of water by increasing the salt concentration or other organic compound concentration in the water may increase the density of the water, and thus, the drilling fluid. Suitable salts may include, but are not limited to, alkali metal halides, such as chlorides, hydroxides, or carboxylates. In one or more embodiments, salts included as part of the aqueous-based fluid may include salts that disassociate into ions of sodium, calcium, cesium, zinc, aluminum, magnesium, potassium, strontium, silicon, lithium, chlorides, bromides, carbonates, iodides, chlorates, bromates, formates, nitrates, sulfates, phosphates, oxides, and fluorides, and combinations thereof. Without being bound by any particular theory, brines may be used to create osmotic balance between the drilling fluid and portions of the subterranean formation. Salts present in aqueous-based drilling fluids may affect the electrostatic interactions between the polymers described here and the surface of tools used in drilling.

In one or more embodiments, the wellbore fluid may comprise one or more salts in an amount that ranges from about 1 to 300 ppb (pounds per barrel). For example, the drilling fluid may contain the one or more salts in an amount ranging from a lower limit of any of 1, 10, 50, 80, 100, 120, 150, 180, 200, 250, and 280 ppb to an upper limit of any of 20, 30, 40, 50, 70, 100, 120, 150, 180, 200, 220, 240, 260, 280, and 300 ppb, where any lower limit can be used in combination with any mathematically-compatible upper limit.

In one or more embodiments, the wellbore fluid may include at least one pH adjuster. The drilling fluid composition may optionally include at least one alkali compound. Examples of alkali compounds may include, but are not limited to, lime (calcium hydroxide, calcium oxide, or a mixture thereof), soda ash (sodium carbonate), sodium hydroxide, potassium hydroxide, and combinations thereof. The alkali compounds may react with gases, such as CO₂ or H₂S (also known as acid gases), encountered by the drilling fluid composition during drilling operations to prevent the gases from hydrolyzing components of the drilling fluid composition. In one or more embodiments, the wellbore fluid compositions may optionally include having a pH adjuster in a range of from about 0.01 wt % to 0.7 wt %, such as from 0.01 wt % to 0.5 wt %, from 0.01 wt % to 0.3 wt %, from 0.01 wt % to 0.1 wt %, from 0.01 wt % to 0.05 wt %, from 0.05 wt % to 0.7 wt %, from 0.05 wt % to 0.5 wt %, from 0.05 wt % to 0.3 wt %, from 0.05 wt % to 0.1 wt %, from 0.1 wt % to 0.7 wt %, from 0.1 wt % to 0.5 wt %, from 0.1 wt % to 0.3 wt %, from 0.3 wt % to 0.7 wt %, from 0.3 wt % to 0.5 wt %, or from 0.5 wt % to 0.7 wt % pH adjuster based on the total weight of the drilling fluid composition. Some drilling fluid compositions may optionally include in a range of from about 0.01 ppb to 10 ppb of at least one pH adjuster based on the total volume of the drilling fluid composition.

The wellbore fluid may have a neutral or alkaline pH. In one or more embodiments, the drilling fluid may have a pH in a range of from about 7 to 11, such as from about 7, 7.5, 8, 8.5, 9, 9.5, and 10 to about 7.5, 8, 8.5, 9, 9.5, 10, 10.5, and 11, where any lower limit may be combined with any mathematically feasible upper limit.

Optionally, in one or more embodiments, the drilling fluid may include weighting agents that may be dispersed in the drilling fluid. The solids may be finely divided having a specific gravity (SG) that when added to an aqueous-based fluid may increase the density of the drilling fluid. Examples of weighting materials suitable for use include, but are not limited to, barite (minimum SG of 4.20), hematite (minimum SG of 5.05), calcium carbonate (minimum SG of 2.7-2.8), siderite (minimum SG of 3.8), ilmenite (minimum SG of 4.6), magnesium tetroxide (minimum SG of 4.8), and combinations thereof.

The wellbore fluid may include an amount of weighting material sufficient to increase the density of the drilling fluid composition to allow the drilling fluid composition to support the wellbore and prevent fluids in downhole formations from flowing into the wellbore. The wellbore fluid composition may include weighting material in a range of from about 1 to about 30 wt % based on the total weight of the drilling fluid composition. For example, the wellbore fluid may contain weighting agents in an amount ranging from about 1 to 700 ppb, such as from about 10 to 650 ppb, from about 50 to 700 ppb, or from about 100 to 600 ppb, or from about 200 to 500 ppb.

In one or more embodiments, the wellbore fluid may have a density in a range of from about 62 pounds cubic foot (pcf) to about 170 pcf as measured using Fann Model 140 Mud Balance according to ASTM Standard D4380. For instance, the wellbore fluid may have a density in a range of from about 63 pcf to 150 pcf, such as from about 65 pcf to 140 pcf, from about 70 pcf to 160 pcf, from about 80 pcf to 150 pcf, from about 90 pcf to 140 pcf, from about 100 pcf to 160 pcf, from about 70 pcf to 150 pcf, from about 70 pcf to 100 pcf, and from about 120 pcf to 160 pcf. The drilling fluid may have a density that is greater than or equal to 62 pcf, such as greater than or equal to 70 pcf, and such as greater than or equal to 100 pcf.

In one or more embodiments, the modified wellbore fluid may include the previously described resin agent. In one or more embodiments, the modified wellbore fluid includes the previously described resin agent and the crosslinking agent. In one or more embodiments, one or more of the agents may be encapsulated. Components of the modified wellbore fluid, such as the resin agents and the crosslinking agent, may be added to the wellbore fluid as needed during continued operations, such as drilling operations, either simultaneously or separately.

### Method of Treating a Loss Circulation Zone

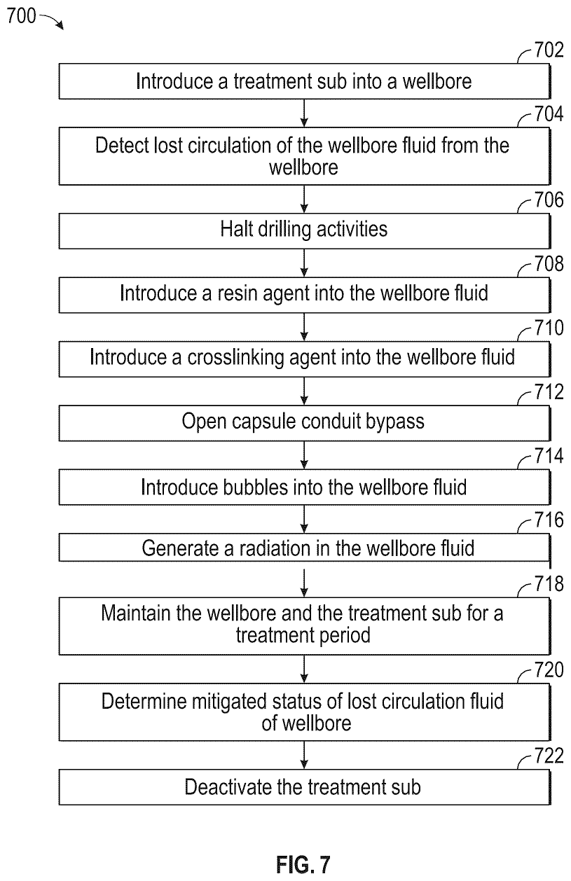

In one or more embodiments, a method of treating a loss circulation zone is disclosed. FIG. 7 is a flow chart depicting a method 700 for treating a lost circulation zone.

In one or more embodiments, a treatment sub is introduced into the wellbore. In FIG. 7, the method 700 includes introducing a previously described treatment sub into a wellbore 702. For example, in FIG. 1, the treatment sub 2000 is shown as part of a BHA 1029 on the distal end of drill string 1026. In one or more embodiments, the treatment sub is part of a bottom hole assembly of a drill string used in the wellbore drilling program. In the case of FIG. 1, one may envision that treatment sub 2000 was previously introduced into wellbore 1014 along with drill bit 1030 as part of a drilling program through a heterogeneous subsurface formation 1004. In one or more embodiments, the treatment sub is introduced as part of a drill string, such as part of a treatment system as previously described. In such a drill string or treatment system configuration, the transmission sub may be utilized during drilling operations without requiring round tripping the string once a lost circulation zone is detected. Based upon the time difference between traversing the LCZ and detection of the LCZ, the treatment sub may be located in the wellbore proximate to the face of the lost circulation zone such that the drill string does not even need to be moved within the wellbore—the drilling can be halted, the lost circulation zone treated, and upon completion of the treatment drilling may be resumed.

In one or more embodiments, the treatment system introduced consists of or consists essentially of the treatment tool coupled to the distal end of a drill pipe, wireline, or coiled tubing. In such a configuration, the treatment sub is not part of a BHA or drill string; rather, the treatment sub is mounted on the end of a drill pipe, wireline, or coiled tubing and is then introduced into the wellbore as a dedicated downhole tool to mitigate a previously-detected lost circulation zone. Such a dedicated treatment sub solution may be utilized in an instance where a prior treatment of the LCZ is not satisfactory or the treatment sub was not initially included as part of a BHA package.

The treatment sub introduced into the wellbore may be configured as previously described, such as the various treatment sub configurations provided for in FIGS. 1, 3A-C, 4A-C, 5A-E, and 6A-C and the associated disclosure. In one or more embodiments, the treatment sub includes an assembly for a single source radiation generator that may treat a full annulus or with full in-pipe coverage.

In one or more embodiments, lost circulation in the wellbore is detected. The method 700 includes detecting lost circulation of the wellbore fluid from the wellbore 704. During drilling operations, a lost circulation zone may be encountered and traversed. One of ordinary skill in the art of drilling mud management has the skill, information, and experience necessary to detect even a minor outflow of wellbore fluid into an underpressurized or non-saturated formation structure, such as a vug, a non-pay sand, or a fault, that may make up a LCZ.

In one or more embodiments, a determination of the rate of outflow through the LCZ may be made. The determination of the rate of outflow may be made from a determination of the rate of loss. The determination of the rate of loss of the LCZ may be categorized as a seepage loss, a partial loss, a severe loss, or a complete loss. In such categorizations, the seepage loss may be up to 1 m³/h (meters cubed per hour), the partial loss may be up to 10 m³/h, the severe loss may be up to 15 m³/h, or the complete loss may yield no return flow.

In making such a determination, a person of ordinary skill may determine, in turn, a sufficient amount of resin agent and crosslinking agent to introduce into the lost circulation zone to mitigate the LCZ. In one or more embodiments, an amount of LCM capsules may be used to treat a severe loss or a complete loss. The amount of LCM capsules and a volume of the LCM capsules should be calculated based on an evaluation of the LCZ. The evaluation of the LCZ may include a determination of the diameter of a drilled area. In an exemplary embodiment, a determined rate of loss is 15 m³/h, and the determined diameter of the loss circulation zone of a drilled area is 12.25 inches. The amount of LCM capsules for LCZ treatment is determined to be 15-20 m³, and the amount of LCM capsules with a cross-linking agent will be determined by a required thickening time. The required thickening time may require a number of LCM capsules with a cross-linking agent in a range of 1000 to 2500 kg (kilograms).

The method 700 includes halting drilling activities 706. In one or more embodiments, halting the wellbore drilling program in response to the detection of lost circulation. In one or more embodiments, the rate of wellbore fluid circulation may be increased in response to the detection of lost circulation. In one or more particular embodiments where the rate of lost circulation is minimal, drilling activities may continue while the LCM agent is introduced. In such embodiments, the LCM agent may be introduced via the drilling mud, for example.

The method 700 includes introducing a resin agent into the wellbore fluid 708. In one or more embodiments, a resin agent is introduced into the wellbore fluid. In one or more embodiments, the resin agent may be encapsulated within a capsule shell. In one or more embodiments, the capsule shell may comprise a polymer shell agent. In one or more embodiments, the capsule shell may further comprise a micro or nano-sized particle susceptible to magnetic waves. In one or more embodiments, the resin agent further comprises a micro-or nano-sized particle susceptible to magnetic waves. In one or more embodiments, the resin agent comprises an epoxide resin. In one or more embodiments, the resin agent further comprises a co-epoxide resin. In one or more embodiments, the resin agent is not encapsulated.

The wellbore fluid may be circulating through the wellbore and processed through the wellbore circulation system on the surface. In one or more embodiments, the resin agent is introduced into the wellbore fluid at the surface. In FIG. 1, for example, resin agent may be introduced into the wellbore fluid 1032 at the surface 1010 using LCM agent capsule injection line 1050 through mud return line 1044.

In one or more embodiments, the resin agent is introduced into the wellbore fluid in the wellbore. As suggested by combining the treatment sub of FIG. 6B with FIG. 1, the resin agent may be in the form of LCM agent capsules 200 and transported internally within a treatment sub 600A, such as by an agent capsule container, downhole as part of either a dedicated treatment tool or as part of a BHA 1029 for a drill string 1026 during drilling operations. In such an instance, introducing the resin agent into the wellbore fluid in the wellbore may be done by transmitting a command signal to the treatment sub.

The treatment sub is operated by sending a command signal from a control system on the surface, such as well control system 1054 of FIG. 1 (comprising control signal lines 1046 and control terminal 1048 of FIG. 1), to the treatment sub, such as through external communication device 336 of treatment sub 300 of FIG. 3A. As previously described, a command signal may be transmitted using one or more known techniques, such as using a dedicated control signal line or mud telemetry. The treatment sub is configured to receive such command signals, interpret them, and operate accordingly.

In one or more embodiments, where the resin agent is introduced into the wellbore fluid in an internal fluid conduit of the treatment sub. In one or more embodiments, the resin agent is introduced into the wellbore fluid in the wellbore annulus of the wellbore. As previously described as part of FIG. 6B, a treatment sub, such as the treatment sub 600B, may be configured such that it permits introduction of the resin agent into the internal fluid conduit, the wellbore annulus, or both.

The method 700 includes introducing a crosslinking agent into the wellbore fluid 710. In one or more embodiments, a crosslinking agent is introduced into the wellbore fluid. The crosslinking agent is encapsulated within a capsule shell. In one or more embodiments, the capsule shell may comprise a polymer shell agent. In one or more embodiments, the capsule shell for the resin agent and the crosslinking agent are comprised of the same shell agent. In one or more embodiments, the capsule shell may further comprise a micro or nano-sized particle susceptible to magnetic waves. In one or more embodiments, the capsule shell of the cross-linking agent is the resin agent. In one or more embodiments, the crosslinking agent is an amine type curing agent. In one or more embodiments, the crosslinking agent further comprises a micro or nano-sized particle susceptible to magnetic waves.

In one or more embodiments, the crosslinking agent is introduced into the wellbore fluid at the surface. In one or more embodiments, the crosslinking agent is introduced into the wellbore fluid in the wellbore. In one or more embodiments, where the crosslinking agent is introduced into the wellbore fluid in an internal fluid conduit of the treatment sub. In one or more embodiments, the crosslinking agent is introduced into the wellbore fluid in a wellbore annulus of the wellbore.

In one or more embodiments, the introduction of each of the resin agent and the crosslinking agent into the wellbore fluid occurs at a same location. In one or more embodiments, the introduction of each of the resin agent and the crosslinking agent into the wellbore fluid occurs at different locations. For example, the resin agent may be introduced into the wellbore fluid at the surface whereas the crosslinking agent may be introduced into the wellbore fluid downhole.

In one or more embodiments, the introduction of both the resin agent and the crosslinking agent into the wellbore fluid may occur simultaneously. In one or more embodiments, the introduction of the resin agent and the introduction of the crosslinking agent into the wellbore fluid may occur sequentially.

Upon introduction of both the resin agent and the crosslinking agent into the wellbore fluid, the modified wellbore fluid forms.

In one or more embodiments, the treatment sub is operated such that a capsule conduit bypass is selectively opened. The method 700 includes operating the treatment sub such that the capsule conduit bypass is opened 712. As previously described, the treatment sub may be operated by transmitting a command signal that results in the treatment sub opening the capsules conduit bypass to be partially opened or fully open.

In one or more embodiments, the treatment sub is operated such that bubbles are introduced into the wellbore fluid. The method 700 includes operating the treatment sub such that the treatment sub introduces bubbles into the wellbore fluid 714. As previously described, the treatment sub may be operated by transmitting a command signal that results in the treatment sub producing a gas that is converted into bubbles using a bubble generator and introduced into the wellbore fluid. In one or more embodiments, the produced bubbles may be introduced into the wellbore fluid of the internal fluid conduit. In one or more embodiments, the produced bubbles may be introduced into the wellbore fluid in the wellbore annulus. FIG. 6C shows both internal and external bubble generators (672, 670) for treatment sub 600B.

In one or more embodiments, the produced bubbles may be generated using a chemical reaction occurring inside the treatment sub. In one or more embodiments, the produced bubbles may be generated using an electrochemical reaction occurring inside the treatment sub. FIG. 6C also shows two systems (6671, 673) for treatment sub 600B to generate the gas used for manufacturing bubbles. In one or more embodiments, the produced bubbles may be generated by discharging a compressed or liquefied gas.

In one or more embodiments, the treatment sub is operated such that a form of radiation is generated in the wellbore fluid. The method 700 includes operating the treatment sub such that the treatment sub generates a form of radiation in the wellbore fluid 716. As previously described, the treatment sub may be operated by transmitting a command signal that results in the treatment sub generating a wavefield in the wellbore fluid of the wellbore. In one or more embodiments, the treatment sub may generate a form of radiation in the wellbore fluid of the internal fluid conduit. In one or more embodiments, the treatment sub may generate a form of radiation in the wellbore fluid of the wellbore annulus.

In one or more embodiments, non-limiting examples of the generated form of radiation may be an electromagnetic radiation, such as an ultraviolet-visible, gamma, microwave, and X-ray, a particle radiation, such as alpha, beta, neutron, and combinations thereof.

In one or more embodiments, the form of radiation generated may be a plurality of forms of radiation. In one or more embodiments, the form of radiation generated may comprise a plurality of types of radiation.

In one or more embodiments, the generated radiation may encompass a portion of the cross-sectional area of the wellbore annulus of the wellbore. In one or more embodiments, the generated radiation may encompass a total cross-sectional area of the wellbore annulus. In one or more embodiments, the radiation may encompass a majority of the cross-sectional area of the wellbore annulus. In one or more embodiments, the wavefield may encompass a substantial cross-sectional area of the wellbore annulus. In one or more embodiments, the radiation may encompass a significant cross-sectional area of the wellbore annulus. In one or more embodiments, the wavefield may encompass a detectable cross-sectional area of the wellbore annulus. In one or more embodiments, the generated radiation may encompass an incidental cross-sectional area of the wellbore annulus. In one or more embodiments, the radiation may encompass an area in a range of from about 0.1 to 100% of the cross-sectional area of the wellbore annulus.

In one or more embodiments, the resin agent and the crosslinking agent may be configured to distinguish radiation susceptible capabilities. For example, a crosslinking agent may be susceptible to one form of radiation, and a resin agent may be susceptible to another form of radiation. In such embodiments, the resin agent and the crosslinking agent may be susceptible to the same form of radiation, such as electromagnetic radiation of different frequencies, the crosslinking agent may be susceptible to a particle radiation and the resin agent susceptible to an electromagnetic radiation, the crosslinking agent may be susceptible to an electromagnetic radiation and the resin agent susceptible to a particle radiation.

In one or more embodiments, the generated radiation may encompass a portion of the cross-sectional area of the internal fluid conduit within the treatment sub. In one or more embodiments, the generated radiation may encompass a total cross-sectional area of the internal fluid conduit. In one or more embodiments, the generated radiation may encompass a majority of the cross-sectional area of the internal fluid conduit. In one or more embodiments, the generated radiation may encompass a substantial cross-sectional area of the internal fluid conduit. In one or more embodiments, the generated radiation may encompass a significant cross-sectional area of the internal fluid conduit. In one or more embodiments, the generated radiation may encompass a detectable cross-sectional area of the internal fluid conduit. In one or more embodiments, the generated radiation may encompass an incidental cross-sectional area of the internal fluid conduit. In one or more embodiments, the generated radiation may encompass an area in a range of from about 0.1 to 100% of the cross-sectional area of the internal fluid conduit.

As previously described in association with FIG. 2, as the resin agent and the crosslinking agent traverse the wellbore into the generated form of radiation. The energy within the generated radiation disrupts the integrity of any capsule shells present, releasing crosslinking agent and resin agent into the wellbore fluid. As well, the energy within the form of radiation may create localized turbulent mixing, such as through cavitation and convective heating, that both increases the reaction rate and improves efficiency of reaction (the amount of resin agent and crosslinking agent that react with one another versus the total amounts of each provided into the wellbore fluid) between the resin agent and the wellbore agent. In embodiments where bubbles are generated downhole by the treatment sub, bubbles in the wellbore fluid that traverse the wavefield collapse, further enhancing capsule shell disruption and fluid mixing by formation of additional fluidic microjets.

The method 700 includes maintaining both the wellbore and treatment sub for a treatment period 718. In one or more embodiments, the method optionally includes maintaining the wellbore and the treatment sub for a treatment period to permit formation and emplacement of the LCM. During this period, a number of actions are occurring in the wellbore: the product LCM is forming in the wellbore fluid from the crosslinking reaction between released resin agent and the crosslinking agent. In and around the generated form of radiation, this process is accelerated as previously described. The product LCM is being circulated by the flow of the wellbore fluid into the face of the lost circulation zone. As the product LCM continues to react and harden into a solid polymer material, the product LCM settles and stacks in the lost circulation zone. This settling and stacking under the influence of differential pressure between the wellbore and the lost circulation zone fluidically seals the LCZ. Upon formation of the fluidic seal by the LCM product, the lost circulation zone has been mitigated.

Maintaining the wellbore during the treatment period includes a number of maintenance actions appreciated by those associated with lost circulation mitigation and general drilling operations, such as monitoring the wellbore fluid properties and detecting any changes to the wellbore fluid returns, such as a decrease or cessation of lost circulation. In one or more embodiments, the treatment period may be in a range of from about 0.1 to 24 hours. The treatment period in some instances may begin upon detection of lost circulation and the cessation of drilling activities. The treatment period in some instances may end upon the determination that lost circulation has been mitigated and drilling activities have resumed.

The method 700 includes determining that lost circulation of the wellbore fluid from the wellbore has been mitigated as shown in 720. One of ordinary skill in the art of drilling mud management has the skill, information, and experience necessary to determine that the lost circulation event has been mitigated by the treatment.

The method 700 includes the option of deactivating the treatment sub 722. One or more command signals may be transmitted to the treatment sub from the surface in order to deactivate the treatment sub depending upon features activated for the treatment. A command signal may be transmitted such that the treatment sub ceases generation of the form of radiation in the wellbore fluid. Other signals may be communicated to the treatment sub. For example, a command signal may be transmitted such that the treatment sub ceases the generation of bubbles. In another example, a command signal may be transmitted such that the treatment sub selectively closes the capsule bypass conduit to halt bypass wellbore fluid flow.

The method 700 includes restarting the wellbore drilling program. In one or more embodiments, the wellbore drilling program may be resumed upon determination of the mitigation of the lost circulation zone.

The systems, apparatuses, and methods of use described here may provide at least one of the following advantages. Due to the targeted release of the resin agent and crosslinking agent, the crosslinking agent does not react with the resin agent in undesirable portions of the formation, where LCM solids may interfere with mechanical tools and devices or may pass through the drill bit nozzles. The reaction that forms the LCM is largely proximate to the face of the lost circulation zone or within the lost circulation zones. In instances where the treatment sub is part of a drill string in active drilling operations, the disruption to drilling operations is minimized. The treatment sub can be quickly positioned near the position of the detected lost circulation zone, the drilling fluid modified by the introduction of the resin agent and the capsules containing LCM resin crosslinking agent, and then treatment of the lost circulation zone with the transmission sub. After treatment, drilling operations may immediately resume.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

When the word “approximately” or “about” are used, this term may mean that there can be a variance in value of up to ±10%, of up to 5%, of up to 2%, of up to 1%, of up to 0.5%, of up to 0.1%, or up to 0.01%.

“Optionally” means that the subsequently described event or circumstances may or may not occur. The description includes instances where the event or circumstance occurs and instances where it does not occur.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims. Thus, particular implementations of the subject matter have been described. Other implementations are within the scope of the following claims.

Although only a few example embodiments have been described in detail, those skilled in the art will readily appreciate that many modifications are possible in the example embodiments without materially departing from the scope of the disclosure. Accordingly, all such modifications are intended to be included within the scope of this disclosure as defined in the following claims. In the claims, means-plus-function clauses are intended to cover the structures described as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims, except for those in which the claim expressly uses the words ‘means for’ together with an associated function.

It is noted that one or more of the following claims utilize the term “where” or “in which” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.” For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open-ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of.” The words “comprise,” “has,” and “include” and all grammatical variations thereof are each intended to have an open, non-limiting meaning that does not exclude additional elements or steps.

1. A treatment sub useful for treating a lost circulation zone, the treatment sub comprising:
a communications device configured to receive an external communication;
an internal fluid conduit configured to convey a wellbore fluid through the treatment sub;
a treatment sub interior defined between a sub exterior surface and the internal fluid conduit; and
a radiation source configured to generate at least one form of radiation in the wellbore fluid.

2. The treatment sub of claim 1, further comprising an agent capsule container positioned in the treatment sub interior.

3. The treatment sub of claim 2, wherein the agent capsule container is configured to selectively direct LCM agent capsules into the wellbore fluid in a wellbore annulus of a wellbore.

4. The treatment sub of claim 2, wherein the agent capsule container is configured to selectively direct LCM agent capsules into the wellbore fluid in the internal fluid conduit.

5. The treatment sub of claim 1, further comprising a capsule conduit bypass traversing the treatment sub interior to provide selective fluid connectivity between the internal fluid conduit and an exterior to the treatment sub.

6. The treatment sub of claim 1, further comprising bubble generator configured to direct generated bubbles into the wellbore fluid.

7. The treatment sub of claim 1, further comprising a chemical reaction system positioned within the treatment sub interior, configured to generate a compressible gas product downhole, and fluidly coupled to a bubble generator.

8. The treatment sub of claim 1, further comprising an electrochemical system positioned within the treatment sub interior, configured to generate a compressible gas product downhole, and fluidly coupled to a bubble generator.

9. The treatment sub of claim 1, wherein the radiation source is further configured such that the form of radiation generated is selected from the group consisting of gamma radiation, ultraviolet radiation, visible radiation, X-ray radiation, alpha radiation, beta radiation, neutron radiation, and combinations thereof.

10. A method of treating a lost circulation zone during a wellbore drilling program, the method comprising:
introducing into a wellbore a treatment sub, where the treatment sub is part of a bottom hole assembly of a drill string used in the wellbore drilling program;
detecting lost circulation of a wellbore fluid from the wellbore;
introducing a resin agent into the wellbore fluid;
introducing a crosslinking agent into the wellbore fluid;
operating the treatment sub such that at least one form of radiation is generated in the wellbore fluid;
maintaining both the wellbore and the treatment sub for a treatment period; and
determining that lost circulation of the wellbore fluid from the wellbore has been mitigated.

11. The method of claim 10, further comprising the steps of:
halting the wellbore drilling program in response to the detecting of lost circulation; and
resuming the wellbore drilling program in response to the determining of mitigation of lost circulation.

12. The method of claim 10, wherein the resin agent comprises an epoxide resin.

13. The method of claim 10, wherein the crosslinking agent is encapsulated within a capsule shell.

14. The method of claim 13, wherein the capsule shell comprises a polymer shell agent.

15. The method of claim 10, wherein the crosslinking agent is an amine type curing agent.

16. The method of claim 10, further comprising operating the treatment sub such that a capsule conduit bypass of the treatment sub is selectively opened.

17. The method of claim 10, further comprising operating the treatment sub such that bubbles are introduced into the wellbore fluid from a bubble generator.

18. The method of claim 10, wherein the detecting comprises determining a rate of fluid loss in the wellbore and a volume of the fluid loss in the wellbore.

19. The method of claim 18, wherein an amount of the resin agent and an amount of the crosslinking agent are selected based on the rate of fluid loss in the wellbore and the volume of fluid loss in the wellbore determined in the detecting of lost circulation.
